(19) United States
(12) Patent Application Publication
(10) Pub. No.: US 2023/0139071 A1
(43) Pub. Date: May 4, 2023

(54) ROOFING MEMBRANE WITH PVC CAP AND CORE

(71) Applicant: JOHNS MANVILLE, Denver, CO (US)

(72) Inventors: Elizabeth R. Griffin, Charlottesville, VA (US); Diego Pedrazzoli, Littleton, CO (US)

(21) Appl. No.: 17/517,880

(22) Filed: Nov. 3, 2021

(51) Int. Cl. E04D 5/10; B32B 5/02; B32B 27/12; B32B 27/08; B32B 27/30

(52) U.S. Cl. CPC E04D 5/10; B32B 5/028; B32B 27/12; B32B 27/08; B32B 27/304; B32B 2262/0284; B32B 2419/06

(57) ABSTRACT

A roofing membrane includes a polyvinyl chloride (PVC) core layer that forms a bottom layer of the roofing membrane and a PVC cap layer positioned atop the PVC core layer so that the PVC cap layer forms a top layer of the roofing membrane. The PVC cap layer includes polyvinyl chloride resin, a solid polymeric plasticizer, a liquid plasticizer, and an acrylic processing aid. The polyvinyl chloride resin has a molecular weight, as expressed in K-value, of between 54 and 75 and the solid polymeric plasticizer has a having a molecular weight (Mw) of between 200,000 and 500,000.

### BACKGROUND

Roofing membranes are commonly used for roofing systems of buildings and other structures. Roofing membranes are often applied to the building or structure's roof to prevent leaks and/or to provide aesthetic appeal. Roofing membranes are commonly made of various synthetic rubber materials, modified bitumen, or thermoplastic materials.

Low slope or flat roofs are typically covered with waterproofing materials. In a “built up roof” (BUR), multiple components such as liquid asphalt and ballast are separately applied to the roof, often over an insulation layer. An alternative to the built-up roof is to use a “singly-ply” membrane, which are commonly large, flat, flexible membranes supplied on a roll, and rolled out on top of the roof, typically on top of an insulation layer. The term “single-ply” is used to describe a roof having a single application of a membrane, but the membrane itself may comprise multiple layers such as polymer layers, reinforcing layers, adhesive layers, coatings, and the like. Typical base materials used for single ply membranes are thermoplastic polyolefin (TPO), ethylene propylene diene monomer (EPDM), polyvinyl chloride (PVC), and modified bitumen.

### BRIEF SUMMARY

The embodiments described herein provide a roofing membrane and methods of forming the same. According to one embodiment, a roofing membrane includes a polyvinyl chloride (PVC) core layer that forms a bottom layer of the roofing membrane and a PVC cap layer positioned atop the PVC core layer so that the PVC cap layer forms a top layer of the roofing membrane. The PVC cap layer includes polyvinyl chloride resin having a molecular weight, as expressed in K-value, of between 54 and 75, a solid polymeric plasticizer having a having a molecular weight (Mw) of between 200,000 and 500,000, a liquid plasticizer, and an acrylic processing aid.

The PVC cap layer may include between 50 and 80 weight percent of the polyvinyl chloride resin, between 1 and 50 weight percent of the solid polymeric plasticizer, between 10 and 40 weight percent of the liquid plasticizer, and between 0.5 and 5 weight percent of the acrylic processing aid. The solid polymeric plasticizer may include ethylene butyl acrylate carbon monoxide copolymers. The liquid plasticizer may include a linear phthalate, a branched phthalate, a trimellitate, a combination of said materials, and the like. The acrylic processing aid may include a fusion aid, a lubricating processing aid, a high molecular weight lubricant, a combination of said materials, and the like.

The roofing membrane may include a fiber scrim that is positioned between the PVC core layer and the PVC cap layer. In such embodiments, the fiber scrim may include, or consist of, polyester or polyethylene terephthalate fibers. The roofing membrane may also include, or alternatively include, a fleece backing applied to a bottom surface of the PVC core layer. In such embodiments, the fleece backing may include, or consist of, polyester or polyethylene terephthalate.

According to another embodiment, a roofing membrane includes a polyvinyl chloride (PVC) core layer and a PVC cap layer that is positioned atop the PVC core layer. The PVC cap layer includes polyvinyl chloride resin having a molecular weight, as expressed in K-value, of between 54 and 75 and a solid polymeric plasticizer having a molecular weight (Mw) of between 200,000 and 500,000. The PVC cap layer may also include a liquid plasticizer and/or an acrylic processing aid.

In some embodiments, the roofing membrane includes a reinforcing scrim that is disposed between the PVC core layer and the PVC cap layer and/or a fleece backing applied to a bottom surface of the PVC core layer. The PVC cap layer may include between 50 and 80 weight percent of the polyvinyl chloride resin and between 18 and 25 weight percent of the solid polymeric plasticizer. The solid polymeric plasticizer may include, or consist of, ethylene butyl acrylate carbon monoxide copolymers.

According to another embodiment, a method of making a roofing membrane includes extruding a first polyvinyl chloride (PVC) material to form a PVC core layer of the roofing membrane and extruding a second PVC material atop the PVC core layer to form a PVC cap layer of the roofing membrane. The PVC cap layer includes polyvinyl chloride resin having a molecular weight, as expressed in K-value, of between 54 and 75 and a solid polymeric plasticizer having a having a molecular weight (Mw) of between 200,000 and 500,000.

The method may also include positioning a reinforcing scrim between the PVC core layer and the PVC cap layer and/or bonding a fleece backing to a bottom surface of the PVC core layer. The PVC cap layer may include between 50 and 80 weight percent of the polyvinyl chloride resin and between 18 and 25 weight percent of the solid polymeric plasticizer.

### BRIEF DESCRIPTION OF THE DRAWINGS

The present technology is described in conjunction with the appended figures:

FIG. 1 illustrates a roofing membrane including a PVC cap and a bottom layer, such as a PVC core.

FIG. 2 illustrates a roofing membrane including a PVC cap, a PVC core, and a reinforcing scrim.

FIG. 3 illustrates a roofing membrane including a PVC cap, a PVC core, and a backing layer.

FIG. 4 illustrates a method of making or forming a roofing membrane.

FIGS. 5-7 illustrate measured molecular weight distributions for various Elvaloy HP® resins.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

Roofing systems often include various materials and/or layers in addition to the roofing membranes. These layers/materials are typically positioned under the roofing membrane and may include support members (e.g., wood and/or metal beams), insulation layers (e.g., foam and/or other insulating boards), and/or other boards or members. The roofing membrane may be coupled with one or more of these materials via ballasting, mechanically fastening, adhesive bonding, heat welding, and the like. Common roofing membranes include various materials, including thermoset materials such as ethylene propylene diene monomer (EPDM), or thermoplastic materials such as thermoplastic polyolefin (TPO) and polyvinyl chloride (PVC). PVC roofing membranes advantageously offer high chemical stability and fire resistance with extended longevity, for example upwards of 25 to 30 years.

The embodiments described herein relate to roofing membranes, and specifically to roofing membranes that include a polyvinyl chloride (PVC) cap or top layer. The PVC cap layer offer excellent chemical stability and fire resistance with extended longevity (25-30 years) when compared to TPO and EPDM roofing membranes. The PVC cap layer also provides improved mechanical and physical properties at low temperatures and superior chemical stability when compared to conventional PVC membranes. The PVC cap layer includes a combination of lower molecular weight PVC resin and a solid polymer plasticizer. The PVC cap commonly also includes a high molecular weight processing aid, which is commonly an acrylic processing aid. The PVC cap layer may also include one or more liquid polymer plasticizers that aid in processing the PVC material. In a specific embodiment, the solid polymer plasticizer may comprise or consist of ethylene butyl acrylate carbon monoxide copolymers with a broad molecular weight distribution.

The PVC cap provides the roofing membrane with a smooth surface, which may be desirable for aesthetic and functional purposes. For example, the PVC cap ensures that the roofing membrane, and the roof of a building or structure, has a smooth and consistent visual appearance, which is typically an important aesthetic function of roofing membranes. In addition, the smooth surface of the PVC cap ensures that dirt or other debris is not trapped on the surface of the PVC cap. The smooth surface allows the dirt and debris to easily wash away from the roof surface after a rainstorm or periodic roof cleaning. The improved chemical stability in comparison with conventional PVC membranes ensures that the roofing membrane continues to provide these aesthetic and functional purposes for a substantial amount of time, typically the entire life or duration of the roofing membrane.

The roofing membrane may also include a bottom layer that is positioned below the PVC cap layer. In some embodiments, the bottom layer may also be made of a PVC material. The PVC cap material may cover and protect the bottom layer (e.g., PVC core layer) from degradation, which may allow the bottom layer to be made of lower grade materials in comparison with the PVC cap. For example, a PVC core may include a combination of PVC resin and one or more liquid polymer plasticizers. The PVC core may include a minor amount of solid polymer plasticizers. In a specific embodiment, the PVC core may include a negligible amount, or essentially no measurable amount, of solid polymer plasticizers. The PVC cap and/or PVC core may also include other materials, such as one or more pigment materials, fire retardants, antioxidant materials, antimicrobial materials, and the like.

In some embodiments, a reinforcing scrim may be positioned between the PVC cap and bottom layer. The reinforcing scrim may add dimensional stability and reinforcement to the roofing membrane. The reinforcing scrim may be a fiber scrim material that may include a variety of fiber materials. In some embodiments, a fleece backing may be added to a bottom surface of the bottom layer. The fleece backing may enable the roofing membrane to be easily attached or adhered to other layers of the roofing system. The roofing membrane is commonly a single-ply roofing membrane.

PVC layers, such as the PVC core, that include minor or negligible amounts of solid polymeric plasticizers have a significantly different chemical composition in comparison with PVC roofing membranes that includes both liquid and solid polymeric plasticizers, such as the PVC cap. PVC roofing membranes that contain solid polymeric plasticizers offer superior longevity, better mechanical and physical properties at low temperatures, and superior chemical stability when compared to PVC membranes that only contain liquid plasticizers.

In some embodiments, the PVC cap employs a lower molecular weight PVC resin, which is balanced with a specific choice of liquid plasticizers. In such embodiments, the molecular weight of the PVC resin and the type and amount of liquid plasticizer is critical to ensuring that the PVC cap provides the desired aesthetic and functional properties described herein. The molecular weight of the PVC resin corresponds with the viscosity of the PVC resin, which is commonly measured as a K-value. The viscosity of the PVC resin may have a K-value of between 54 and 75, more commonly a K-value of between 58 and 72, and more commonly a K-value of a between 65 and 69. In a specific embodiment, the PVC resin may have a K-value of between 67 and 69. The K-values of the PVC resins described herein are lower than those commonly used in roofing membranes, which corresponds to PVC resins with lower molecular weights. Liquid PVC resins with higher molecular weights are used in conventional roofing membrane to provide strength. In contrast, the embodiments described herein use lower molecular weight PVC resins in order to provide improved processing flow and surface quality. The strength of the roofing membrane is provided by broad molecular weight solid plasticizer and the fusion that results from the processing aids.

The amount of liquid plasticizers that is employed with the lower molecular weight PVC resins may range between 5 and 50 weight percent, more commonly between 10 and 35 weight percent, and most commonly between 15 and 22 weight percent of the total weight of the compound. The liquid plasticizers may be different types of branched or linear phthalates. In a specific embodiment, the liquid plasticizer may include, or consist of, linear phthalates with 9 or more carbons (e.g., 9, 10, 11, and the like carbons).

In other embodiments, the PVC cap employs a combination of liquid and solid polymeric plasticizers. The molecular weight of the PVC resin is typically the same as that described in the preceding paragraph. The type of the liquid plasticizer may also be the same as that described in the preceding paragraph. The amount of the liquid plasticizer, however, is typically lower due to the use of a solid polymeric plasticizer in the PVC cap. For example, the PVC cap may include between 1 and 49 weight percent of the liquid plasticizer, between 10 and 35 weight percent of the liquid plasticizer, and more commonly between 15 and 22 weight percent of the liquid plasticizer. The PVC cap may also include between 1 and 50 weight percent of the solid polymeric plasticizer, between 10 and 35 weight percent of the solid polymeric plasticizer, and more commonly between 18 and 25 weight percent of the solid polymeric plasticizer. The solid polymeric plasticizer may have a broad molecular weight distribution. For example, the polydispersity of the solid polymeric plasticizer may be between 8 and 12, more commonly between 9 and 11, and most commonly between 10 and 10.5. In a specific embodiment, the solid polymeric plasticizer comprises or consists of ethylene butyl acrylate carbon monoxide copolymers.

The PVC cap commonly also includes one or more process aids, such as an acrylic processing aid, that provides both improved processing and stability. When the roofing membrane includes a PVC core, the PVC core may include materials that are identical or similar to the PVC cap materials described herein. In a specific embodiment, the PVC core may include one or more of the following materials: heat stabilizers, heat co-stabilizers, lubricant, antioxidant, antimicrobial, acrylic processing aids, flame retardant, calcium carbonate, black pigment, color concentrate, recycled PVC, and the like. The PVC cap may also include one or more of these materials and commonly also includes a UV stabilizer. The PVC core and cap typically have different compositions or formulations based on their different functions. For example, the PVC core is commonly designed to be compatible with specific adhesives and to be adhered to the PVC cap. The PVC core typically does not contain UV stabilizers and may include lower costs pigments and filler materials, such as recycled PVC.

The use of a PVC resin having a molecular weight, expressed as a K-value of between 54-75, 58-72, 65-69, or 67-69 as described herein, allows the solid polymeric plasticizer to be used in manufacturing the roofing membrane. The use of the process aids enables a solid polymeric plasticizer to be used. Conventional PVC roofing materials do not employ solid polymeric plasticizer due to the increased complexity in manufacturing the roofing membrane and due to the fact that conventional solid polymeric plasticizers often result in PVC materials that exhibit wrinkled or textured outer surfaces, which are neither visually appealing nor functionally acceptable. In contrast to these conventional roofing membranes, the PVC cap described herein is capable of using solid polymeric plasticizers while maintaining a smooth outer surface. The smooth outer surface is due, in part, to the molecular weight distribution of the solid polymeric plasticizer which is compatible with the selected PVC resin, lubricants and additives. More specifically, mixing of the solid polymeric plasticizer with the selected PVC resin produces a final thermoplastic polymer that is morphologically stable during and after the manufacturing process (i.e. no phase separation), and has rheological properties leading to the desired surface quality.

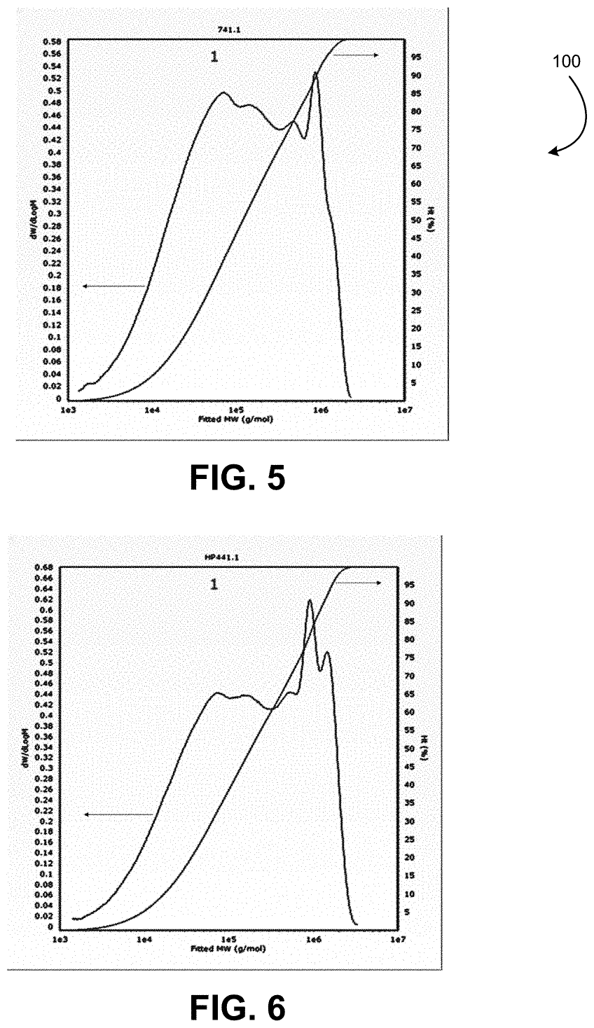

As used herein, the PVC resin means a polyvinyl chloride resin in the form of pellets or dry blend to be mixed with selected plasticizers and additives. Similarly, as used herein, the term solid polymeric plasticizer means a plasticizer with a molecular weight distribution, or weight average molecular weight, (Mw) between 200,000 and 500,000, more commonly between 300,000 and 500,000, with a polydispersity index (PD) between 8 and 12, 9 and 11, or 10 and 10.5. The selected polymeric plasticizer is compatible with the typical industrial grades of PVC resin having a molecular weight, expressed as a K-value, of between 54-75, 58-72, 65-69, or 67-69. The term liquid plasticizer means a liquid substance that is added to the PVC resin to make it softer and more flexible. The liquid plasticizer may be characterized by a molecular weight between 300 and 5,000, and more commonly between 300 and 1,000. The term scrim reinforcement as used herein, means fiber yarns that are glued or coupled together to form an open mesh structure. The fibers are commonly glass, polyester, or Kevlar fibers that are coated or uncoated with specific coupling agents/sizings. The scrim is typically used to provide structural reinforcement and dimensional stability to the roofing membrane. The term fleece backing as used herein, means an open mesh structure, made up by randomly-arranged fibers (e.g., polyester fibers), that is attached to the core layer of the roofing membrane. The fleece allows the roofing membrane to be installed on different substrates, using various types of glues and adhesives. The term molecular weight distribution is related to different molecular weight averages (Mₚ, Mₙ, M_{w}, M_{z}, etc.) and the polydispersity index (PD) as reported in the Table 1 below and as illustrated in FIG. 5. All measured values of molecular weight averages and PD are typical for the solid polymeric plasticizers under consideration, where a limited deviation is expected from measurement to measurement.

TABLE 1
Molecular Weight Averages and Polydispersity Index for Various
Solid Plasticizers

| Sample | | | | | | | |
|---|---|---|---|---|---|---|---|
| ID | Mp | Mn | Mw | Mz | Mz + 1 | Mv | PD |
| HP441.1 | 904554 | 41960 | 443863 | 1118999 | 1486227 | 1053873 | 10.58 |
| HP441.2 | 910626 | 42831 | 434990 | 1052574 | 1372830 | 994772 | 10.16 |
| HP661.1 | 157788 | 45677 | 275717 | 667142 | 941570 | 621364 | 6.036 |
| HP661.2 | 158847 | 44424 | 276426 | 673719 | 954813 | 627190 | 6.222 |
| 741.1 | 863168 | 33513 | 298733 | 799869 | 1102614 | 746954 | 8.914 |
| 741.1 | 863168 | 33047 | 290358 | 770936 | 1064855 | 719825 | 8.786 |

The term process agent stabilizer, or stabilizing agents, as used herein, means a specific additive that is used in order to avoid thermal degradation and oxidation of the resin during processing. The term process aids as used herein, means a specific additive that is used to control the viscosity of the entire formulation during processing.

Having described various aspects of the roofing membrane generally, and in particular the PVC cap, additional details of the roofing membrane and the PVC cap will be readily apparent in relation to the description of the several figures, which is provided herein below.

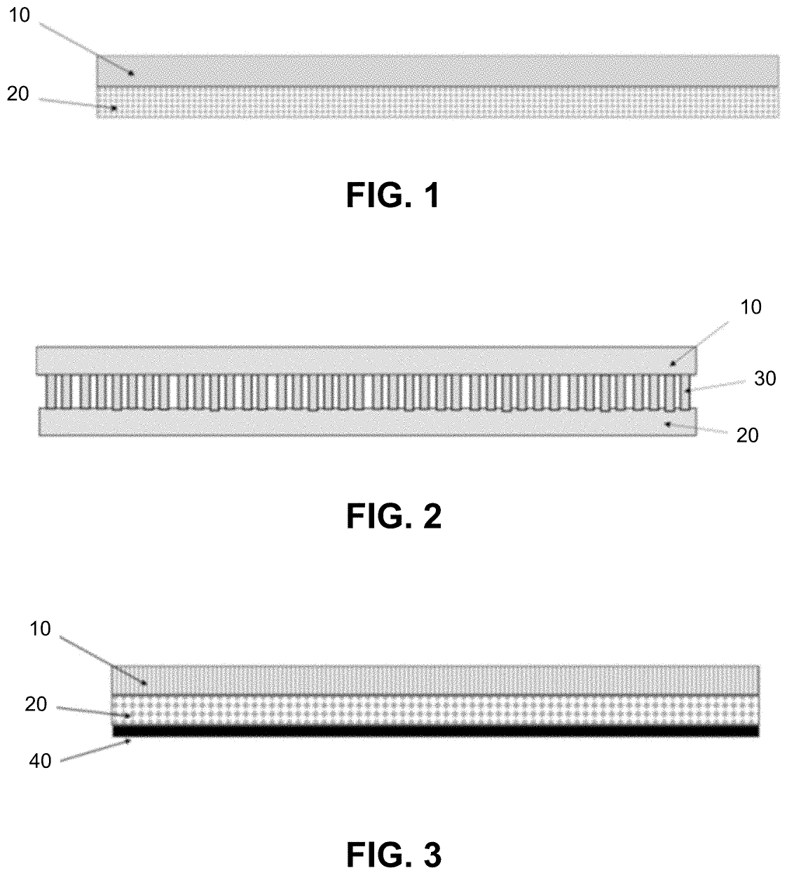

FIG. 1 illustrates a roofing membrane that includes a PVC cap 10 and a bottom layer 20. The bottom layer 20 may be formed of various roofing materials. In a specific embodiment, the bottom layer 20 is formed of a PVC material. For ease in describing the embodiments herein, the bottom layer 20 will be referred to hereinafter as a PVC core 20. The PVC core 20 is typically made of a different PVC material than the PVC cap 10. For example, the PVC core 20 is typically made of a lower grade PVC material than the PVC cap 10. In some instances, however, the PVC core 20 and the PVC cap 10 may be identical or nearly identical in composition.

The PVC core 20 forms a bottom layer of the roofing membrane, which is designed for positioning and attaching to an upper surface of a building or structure. The PVC cap 10 is positioned atop the PVC core 20 and is coupled or joined to the PVC core 20 along a seam or interface between the materials. In some instances, the PVC cap 10 may be extruded onto the PVC core 20 during manufacturing of the two materials. In other embodiments, the PVC core 20 and PVC cap 10 may be formed separately and joined or laminated together at a later stage via adhesive or any other known boding technique known or otherwise developed in the art.

The PVC cap 10 forms a top layer of the roofing membrane and is typically exposed to an external environment. The PVC cap 10 performs various functions, such as weather proofing the roofing system and underlying building or structure, minimizing degradation of the roofing system components from solar radiation or weather exposure, providing a desired visual appearance, and the like. The upper surface of the PVC cap 10 is smooth and visually appealing. A smooth upper surface, as described herein, means that the surface does not include significant visible indications of roughness or non-smoothness, or any significant surface inconsistency. Visually unappealing roofing membranes include wrinkling, roughness, and other visual features that are commonly referred to as “chevrons”. The PVC cap formulations described herein avoid surface inconsistencies, chevrons, and the like, which renders the PVC cap 10 more visually appealing.

The PVC cap 10 includes or consists of a polyvinyl chloride resin (PVC resin), one or more a solid polymeric plasticizers, one or more liquid plasticizers, one or more processing aids, and one or more filler materials. The PVC resin may have a molecular weight expressed as a K-value, of between 54-75, 58-72, 65-69, or 67-69. The one or more solid polymeric plasticizers may have a molecular weight (Mw) 210,000 and 500,000, more commonly between 350,000 and 450,000, and more commonly between 400,000 and 450,000. The processing aid may be an acrylic processing aid. When the PVC resin is mixed and compounded with the liquid plasticizer and/or solid plasticizer, and other additives and fillers, a final “compound” is obtained where the liquid plasticizer is stable in a solid state. The PVC resin is softened due to the presence of the plasticizers. The final product is uniform and stable under standard conditions.

The acrylic process aid, including fusion aids and lubricating processing aids, may be a high molecular weight lubricant. Examples of suitable process aids include the product Plastistrength® sold by Arkema S.A.®, the product Paraloid® sold by The Dow Chemical Company®, and the product PlastiStab® sold by AM Stabilizers Corporation®. The fillers that may be used in the PVC cap 10 may include a heat stabilizer, a heat co-stabilizer, an antioxidant, a pigment, and/or an antimicrobial material. Examples of suitable filler materials include lubricant, acrylic processing aids, a flame retardants, a UV stabilizer, calcium carbonate, a color concentrate, recycled PVC, and the like. The result of the above described combination of materials results in a high quality PVC sheet that is both aesthetically pleasing and highly functional.

In one embodiment, the PVC cap 10 is formed of a lower molecular weight PVC resin, which is balanced with a specific choice of liquid plasticizers. In such embodiments, the molecular weight of the PVC resin expressed as a K-value, of between 54-75, 58-72, 65-69, or 67-69. The PVC cap 10 may include between 50 and 80 weight percent of the PVC resin. The liquid plasticizer that is used in forming the PVC cap 10 may be a linear or branched phthalate or trimellitate, or any combination of them, such as diisodecyl phthalate (DIDP), di-iso-undecyl phthalate (DIUP), ditridecyl phthalate (DTDP), di iso nonyl phthalate (DINP), dioctly terephthalate (DOTP), linear nonyl phthalate (L9P), linear nonyl undecyl phthalate (L911P), linear undecyl phthalate (L11P), Tris (2-Ethylhexyl) Trimellitate (TOTM), triisononyl trimellitate (TINTM), linear trinonyltrimellitate (L9TM). DOTP is typically not able to be used in roofing membranes. However, the formulations described herein, and in particular the use of Elvaloy, enables DOTP to be used since Elvaloy increases permanence. The liquid plasticizer may be applied in an amount between 10 and 40 weight percent of the total weight of the compound. The PVC cap 10 is also formed via one or more process aids, which may be applied in an amount between 0.5 and 5 weight percent of the total weight of the compound. One or more fillers as described herein, may also be used in forming the PVC cap 10. The fillers may be applied in an amount between 0.5 and 15 weight percent of the total weight of the compound.

In other embodiments, the PVC cap 10 is formed of a lower molecular weight PVC and one or more solid plasticizers. The molecular weight of the PVC resin expressed as a K-value, of between 54-75, 58-72, 65-69, or 67-69. The PVC cap 10 may include between 50 and 80 weight percent of the PVC resin. The solid polymeric plasticizer that is used in forming the PVC cap 10 may be an ethylene copolymer comprising, or consisting of, copolymerized units of ethylene and copolymerized units of a comonomer selected from the group consisting of C3-C12 ethylenically unsaturated monocarboxylic acids and salts thereof, C1-C18 alkyl esters of ethylenically unsaturated C3 C12 monocarboxylic acids, vinyl esters of C3-C18 saturated carboxylic acids, carbon monoxide and combinations thereof. The ethylene copolymer may include ethylene/acrylate copolymer, ethylene/vinyl acetate copolymer, ethylene/acrylate/carbon monoxide copolymer, ethylene/vinyl acetate/carbon monoxide copolymer, ethylene/acrylic acid copolymer, ethylene/methacrylic acid copolymer, salts derivable from ethylene/methacrylic and/or acrylic acid copolymer, ethylene/acrylic ester copolymer, ethylene/methacrylic ester copolymer, or combinations of two or more thereof. As an alternative, the solid polymeric plasticizer may include, or consist of, a butyl acrylate grade polymer. The solid polymeric plasticizer may be applied in an amount between 1 and 30 weight percent of the total weight of the compound. The PVC cap 10 is also formed via one or more process aids, which may be applied in an amount between 0.1 and 5 weight percent of the total weight of the compound.

In some embodiments, the PVC cap 10 may not use any liquid plasticizers, or may use a negligible or non-substantial amount of liquid plasticizers. In such embodiments, the plasticizer that is used in forming the PVC cap 10 may consist of, or essentially consist of, solid polymeric plasticizers. In other embodiments, however, the PVC cap may include some amount of liquid plasticizers. In such embodiments, the liquid plasticizer that is used in forming the PVC cap 10 may be a linear or branched phthalate or trimellitate, or any combination of them, such as DIDP, DIUP, DTDP, L9P, L911P, L11P, TOTM, TINTM, L9TM. The liquid plasticizer may be applied in an amount between 10 and 40 weight percent of the total weight of the compound. The PVC cap 10 is also typically formed via one or more process aids, which may be applied in an amount between 0.1 and 5 weigh percent. One or more fillers as described herein, may also be used in forming the PVC cap 10. The fillers may be applied in an amount between 0.1 and 15 weight percent of the total weight of the compound.

A specific type of solid polymeric plasticizer that may be used in forming the PVC cap 10 is sold by The Dow Chemical Company® under the tradename Elvaloy® and Elvaloy HP®, such as Elvaloy® HP661, Elvaloy® 741, Elvaloy® 742, Elvaloy® HP551, Elvaloy® HP553, Elvaloy® 662HP®, Elvaloy® HP441, etc., or combinations thereof. In a specific embodiment, the solid polymeric plasticizer that is used in forming the PVC cap 10 includes, or consists of, Elvaloy® HP441, which may be particularly useful in achieving the outcomes described herein.

Elvaloy® is a random polymerized ethylene copolymer. Random polymerization creates highly branched polymers with wide molecular weight distributions. Elvaloy HP® resins are copolymers with a monomer having greater thermal stability but higher elasticity of the branched molecules. Increased elasticity of the branched molecules may result in the formation of surface roughness and chevrons in the membrane surface. Elvaloy® HP661, Elvaloy® HP662, Elvaloy® 741, and Elvaloy® 742 are designed to reduce the branched polymers having higher elasticity molecules. The roofing membranes may include or consists of these solid polymeric plasticizer, or may include or consist of solid polymeric plasticizer that include significant branched polymers having higher elasticity molecules, such as Elvaloy® HP441. The formulations described herein allow both types of solid polymeric plasticizers to be used—i.e., ethylene copolymer having significant branched higher elasticity molecules and ethylene copolymer having significantly reduced branched higher elasticity molecules. When ethylene copolymers having significant branched higher elasticity molecules are used (e.g., Elvaloy® HP441), a higher thermal stability is achieved without the formation of surface roughness and chevrons in the membrane surface.

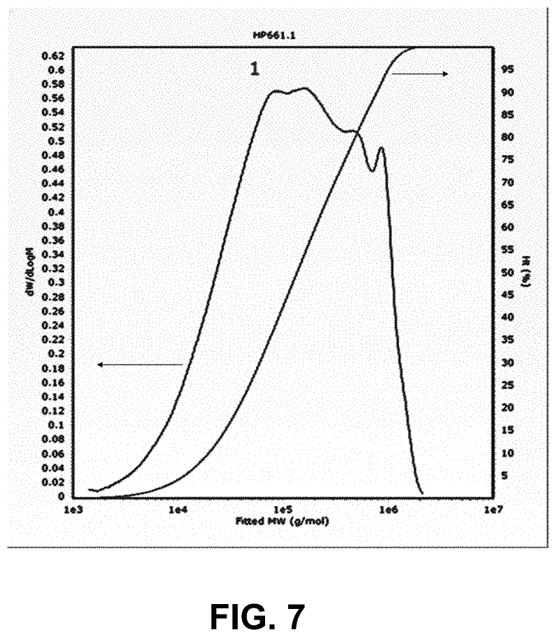

FIGS. 5-7 illustrate measured molecular weight distributions for various Elvaloy HP® resins. More specifically, FIG. 5 illustrates a measured molecular weight distribution for Elvaloy® 741, FIG. 6 illustrates a measured molecular weight distribution for Elvaloy® HP441, and FIG. 7 illustrates a measured molecular weight distribution for Elvaloy® HP661. In FIGS. 5.7, the left Y-axis indicates the amplitude of the signal recorded for a specific molecular weight value (X-axis). The right Y-axis indicates the cumulative function (0 to 100%) with respect to a specific molecular weight value (X-axis).

As illustrated in FIGS. 5-7, each of the Elvaloy HP® resins exhibits a unique molecular weight distribution. For example, the molecular weight distribution of Elvaloy® HP441 illustrated in FIG. 6 allows for significant branching, which results in higher elasticity in the final compound. More specifically, the molecular weight of the Elvaloy® HP441 is more bimodal and creates more elasticity than the Elvaloy® HP661 illustrated in FIG. 7. The butyl acrylate monomers in the HP grades creates more elasticity than the Vinyl acetate monomer in other grades, such as Elvaloy® 741 illustrated in FIG. 5, and Elvaloy® 742. The increased elasticity of the Elvaloy® HP441 would be expected to create the visually unappealing outer surface characteristics noted herein. The compositions described herein, however, overcome these expected outer surface characteristics by providing better fusion and improved surface, which enables materials such as Elvaloy® HP441 to be used in forming the roofing membrane.

The use of a solid polymeric plasticizer in the PVC cap 10 may result in the PVC cap 10 having a longer life, better chemical resistance, and better thermal resistance (i.e., improved low temperature properties) in comparison with conventional PVC roofing materials. Solid polymeric plasticizers, however, are not typically used in conventional PVC roofing materials because the PVC material is difficult to process and because the use of such materials may result in a visually unappealing outer surface, such as a surface that appears nervy, wrinkled, or veiny. A nervy, wrinkled, or veiny PVC surface is both visually unappealing and functionally deficient since such a surface will collect dirt and debris and is more difficult to clean.

The solid polymeric plasticizer used herein typically has a molecular weight that is greater than the molecular weight of the PVC resin. This is opposite of the composition of conventional PVC roofing materials in which the molecular weight of the PVC resin is commonly greater than the molecular weight of the liquid plasticizer. The molecular weight of the solid polymeric plasticizer may be 8 to 13 times greater than that of the PVC resin. PVC resins with molecular weight greater than those described herein are commonly used in forming flexible PVC roofing membranes since such membranes are relatively easy to process. Lower molecular weight resins are commonly used in forming rigid PVC materials that are substantially different than roofing membranes.

The use of solid polymeric plasticizers with a molecular weight that is greater than the PVC resin results in the polymeric plasticizer not migrating within the resulting PVC material. The use of a solid polymeric plasticizers with a molecular weight that is greater than the PVC resin, may enhance the strength and longevity of the resulting PVC material in addition to providing the other functional properties described herein. When compared to a PVC formulation based only on liquid plasticizers, the use of a solid polymeric plasticizer, such as the Elvaloy® materials described herein, may result in a significant improvement in cold temperature flexibility (down to −50° C.), increased heat weldability, improved thermal stability, improved chemical resistance with respect to diesel fuel, jet fuel, animal fat oils and vegetable oils, and higher resistance to heat and UV degradation.

In some embodiments, the PVC core 20 may include a PVC resin expressed as a K-value, of between 54-75, 58-72, 65-69, or 67-69. The PVC core 20 may also include a liquid plasticizer, a heat stabilizer, a heat co-stabilizer, an antioxidant, one or more processing aids, a pigment, an antimicrobial material, and/or one or more filler materials. The liquid plasticizer may be a linear or branched phthalate or trimellitate, or any combination of them, such as DIDP, DINP, DOTP, DIUP, DTDP, L9P, L911P, L11P, TOTM, TINTM, L9TM. The processing aid may be an acrylic filler and the one or more filler materials may be a lubricant, a flame retardants, a UV stabilizer, calcium carbonate, a color concentrate, and/or recycled PVC. The PVC core 20 may include between 50 and 80 weight percent of the PVC resin, between 10 and 40 weight percent of the liquid plasticizer, and between 0.1 and 15 weight percent of the filler materials.

In some embodiments, the PVC core 20 may not include a solid polymeric plasticizer, or may include a negligible amount of solid polymeric plasticizer. In other embodiments, the PVC core 20 may include a solid polymeric plasticizer. In such embodiments, the PVC core 20 typically includes a lesser amount of the solid polymeric plasticizer material than the PVC cap 10, although the amount of solid polymeric plasticizer used in each layer may be roughly equal or may be greater in the PVC core 20 in some instances. For example, the PVC core 20 may include between 10 and 90 percent of the amount of the solid polymeric plasticizer used in the PVC cap 10, between 10 and 60 percent of the amount of solid polymeric plasticizer, between 10 and 50 percent of the amount of solid polymeric plasticizer, between 10 and 40 percent of the amount of solid polymeric plasticizer, or between 10 and 30 percent of the amount of solid polymeric plasticizer. In specific embodiments, the PVC core 20 may include between 1 and 25 percent of the amount of solid polymeric plasticizer used in the PVC cap 10, between 1 and 15 percent of the amount of solid polymeric plasticizer, between 1 and 10 percent of the amount of solid polymeric plasticizer, or between 1 and 5 percent of the amount of solid polymeric plasticizer.

In a specific embodiment in which the roofing membrane includes only liquid plasticizers, the roofing membrane includes, or consists of, a PVC core 20 and a PVC cap 10 in which the PVC core 20 includes, or consists of, PVC resin (100 PHR), a heat stabilizer (3-4 PHR), a heat co-stabilizer (2-4 PHR), a liquid plasticizer (50-56 PHR), one or more additives (lubricant, antioxidant, and antimicrobial) (1.0-1.8 PHR), an acrylic processing aid (2 PHR), a black pigment (0.2 PHR), a fire retardant (3-5 PHR), a pigment and UV absorber (TiO2) (4 PHR), and calcium carbonate (12-14 PHR), and in which the PVC cap 10 includes, or consists of, PVC resin (100 PHR), a heat stabilizer (3-4 PHR), a heat co-stabilizer (2-4 PHR), a liquid plasticizer (50-56 PHR), one or more additives (lubricant, UV stabilizer, antioxidant, antimicrobial) (1-4 PHR), an acrylic processing aid (1.5-3 PHR), a fire retardant (3-4 PHR), a pigment and UV absorber (TiO₂) (10-12 PHR), and calcium carbonate (8-12 PHR).

In another specific embodiment in which the roofing membrane includes both liquid and solid polymeric plasticizers, the roofing membrane includes, or consists of, a PVC core 20 and a PVC cap 10, in which the PVC core 20 includes, or consists of, PVC resin (100 PHR), a heat stabilizer (3.5-5 PHR), a heat co-stabilizer (3-5 PHR), a liquid plasticizer (33-37 PHR), one or more additives (lubricant, antioxidant, antimicrobial) (1-2.5 PHR), an acrylic processing aid (1.8-3 PHR), a black pigment (0.2 PHR), a fire retardant (2-3 PHR), a pigment and UV absorber (TiO2) (4-5 PHR), calcium carbonate (7-10 PHR), and a solid polymeric plasticizer (22-28 PHR), and in which the PVC cap 10 includes, or consists of, PVC resin (100 PHR), a heat stabilizer (3-5 PHR), a heat co-stabilizer (3-5 PHR), a liquid plasticizer (33-37 PHR), one or more additives (lubricant, UV stabilizer, antioxidant, antimicrobial) (1-2.5 PHR), an acrylic processing aid (1.8-3 PHR), a fire retardant (3 PHR), a pigment and UV absorber (TiO2) (10-12 PHR), calcium carbonate (7-10 PHR), and a solid polymeric plasticizer (22-28 PHR).

In another specific embodiment in which the roofing membrane PVC cap 10 includes both liquid and solid polymeric plasticizers, an in which the PVC core includes only on liquid plasticizers, the PVC core 20 includes, or consists of, PVC resin (100 PHR), a heat stabilizer (3-4 PHR), a heat co-stabilizer (2-4 PHR), a liquid plasticizer (50-56 PHR), one or more additives (lubricant, antioxidant, and antimicrobial) (1-1.8 PHR), an acrylic processing aid (2 PHR), a black pigment (0.2 PHR), a fire retardant (3-5 PHR), a pigment and UV absorber (TiO₂) (4 PHR), and calcium carbonate (12-14 PHR), and the PVC cap 10 includes, or consists of PVC resin (100 PHR), a heat stabilizer (3-5 PHR), a heat co-stabilizer (3-5 PHR), a liquid plasticizer (33-37 PHR), one or more additives (lubricant, UV stabilizer, antioxidant, antimicrobial) (1-2.5 PHR), an acrylic processing aid (1.8-3 PHR), a fire retardant (3 PHR), a pigment and UV absorber (TiO2) (10-12 PHR), calcium carbonate (7-10 PHR), and a solid polymeric plasticizer (22-28 PHR).

In yet another specific embodiment in which the PVC cap 10 and/or PVC core 20 include only solid polymeric plasticizers, the PVC cap 10 may include, or consist of, PVC resin (100 PHR), a heat stabilizer (3-5 PHR), a heat co-stabilizer (5-7 PHR), one or more additives (lubricant, antioxidant, antimicrobial) (1-2.5 PHR), an acrylic processing aid (1.8-3 PHR), a black pigment (0.2 PHR), a fire retardant (2-3 PHR), a pigment and UV absorber (TiO2) (4-5 PHR), calcium carbonate (7-10 PHR), and a solid polymeric plasticizer (50-100 PHR), and/or the PVC core 20 may include, or consist of, PVC resin (100 PHR), a heat stabilizer (4-5 PHR), a heat co-stabilizer (5-7 PHR), one or more additives (lubricant, UV stabilizer, antioxidant, antimicrobial) (1-2.5 PHR), an acrylic processing aid (1.8-3 PHR), a fire retardant (3 PHR), a pigment and UV absorber (TiO2) (10-12 PHR), calcium carbonate (7-10 PHR), and a solid polymeric plasticizer (80-100 PHR). In some embodiments, the PVC core 20 may also include a liquid plasticizer (33-37 PHR).

An example of specific formulations that may be used in various roofing membranes are provided in Table 2 below.

TABLE 2
Exemplary Formulations

| Specific Example | Liquid(only) | | Liquid(only) | | Liquid/Solid | | Liquid/Solid | |
|---|---|---|---|---|---|---|---|---|
| Formulation | Core | | Cap | | Core | | Cap | |
| PVC Resin | 100 | PHR | 100 | PHR | 100 | PHR | 100 | PHR |
| Heat Stabilizer | 3.5 | PHR | 3.5 | PHR | 4.0 | PHR | 4.0 | PHR |
| Heat Co-Stabilizer | 3 | PHR | 3 | PHR | 3 | PHR | 3 | PHR |
| Liquid Plasticizer | 53 | PHR | 53 | PHR | 35 | PHR | 35 | PHR |
| Solid Plasticizer | 0 | | 0 | | 22 | PHR | 25 | PHR |
| Additives | 1.5 | PHR | 2.8 | PHR | 1.3 | PHR | 2.8 | PHR |
| Acrylic Process Aid | 2 | PHR | 2 | PHR | 2 | PHR | 2 | PHR |
| Fire Retardant | 2.5 | PHR | 3 | PHR | 2.5 | PHR | 3 | PHR |
| Pigment/TiO2/UV Absorber | 4.2 | PHR | 12 | PHR | 4.2 | PHR | 12 | PHR |

| | | | | |
|---|---|---|---|---|
| Filler (CaCO3) | 12 | 10 | 8 | 8 |

In some embodiments, the PVC core 20 may have a thickness of between 12 and 50 mils (i.e., between 0.30 and 1.3 mm) and the PVC cap 10 may have a thickness of between 12 and 50 mils (i.e., between 0.30 and 1.3 mm). The thickness of the PVC core 20 is typically greater than the PVC cap 10 because the main function of the PVC cap 10 is to cover, conceal, and protect the PVC core 20 and underlying materials. However, the PVC cap 10 should be at least 0.3 mm thick in order to ensure the formation of a smooth, visually appealing, top surface and prevent nervy, wavy, or unappealing features of the PVC core 20 from being visible through the PVC cap 10. The roofing membrane may have essentially any length and width, but is commonly between 1.5 and 4 meters wide and between 10 and 40 meters in length.

Referring now to FIG. 2, illustrated is a roofing membrane that includes a PVC cap 10 and PVC core 20. The PVC cap 10 and the PVC core 20 may have a configuration or composition as previously described. A reinforcing scrim 30 is positioned between the PVC cap 10 and the PVC core 20 so that the reinforcing scrim 30 is sandwiched between the two material layers. The reinforcing scrim 30 is roughly equivalent in width and length as the roofing membrane. The reinforcing scrim 30 structurally and dimensionally reinforces and strengthens the roofing membrane, which may be important depending on the end application.

In some embodiments, the reinforcing scrim 30 is made of a fiber material. For example, the reinforcing scrim 30 may include or consist of glass fibers, polyester fibers, polyethylene terephthalate fibers, aramid fibers, cotton, wool, paper, etc., and blends thereof. The reinforcing scrim 30 is typically a woven material, which may be either a finely woven, lightweight fabric or a heavy, coarse woven material. The reinforcing scrim 30 is typically placed atop the PVC core 20 prior to extrusion or lamination of the PVC cap 10 atop the PVC core 20. The reinforcing scrim 30 may be partially or fully embedded in either the PVC core 20 or the PVC cap 10. The reinforcing scrim 30 may be between 5 and 15 mil (i.e., between 0.10 and 0.40 mm) thick.

Referring now to FIG. 3, illustrated is a roofing membrane that includes a PVC cap 10 and PVC core 20. The PVC cap 10 and the PVC core 20 may have a configuration or composition as previously described. A backing layer 40 is positioned on a bottom surface of the PVC core 20. The backing layer 40 is roughly equivalent in width and length as the roofing membrane. The backing layer 40 enables easy attachment of the roofing membrane with a top surface of the roofing structure and/or provides a layer that dampens the roofing system, which may be important depending on the end application.

In some embodiments, the backing layer 40 is made of a fleece material. For example, the backing layer 40 may include or consist of a polyethylene terephthalate or polyester fleece. The backing layer 40 is typically laminated or adhered to the bottom surface of the PVC core 20. The backing layer 40 may be between 10 and 80 mils thick. A backing layer that is based on a polyester or polyethylene terephthalate fleece may provide (i) increased protection to the PVC core when positioning the roofing membrane on rough surfaces, (ii) quiet installation of the roofing membrane, (iii) increased energy efficiency of the overall roof, and/or (iv) enhanced compatibility with a variety of glues and adhesives, leading to improved wind resistance. The roofing membrane of FIG. 3 may be formed without a reinforcing scrim 30 as illustrated, or the roofing membrane may include a reinforcing scrim 30 positioned between the PVC cap 10 and PVC core 20 in addition to the backing layer 40. In the latter embodiment, the roofing membrane may provide a combination of structural and dimensional reinforcement and stability, in addition to improved damping and installation characteristics.

The roofing membranes of FIGS. 2 and 3 may include one or more edges that do not include the reinforcing scrim 30 and backing layer 40. These edges may enable the roofing membrane to be welded (e.g., heat welded) to an adjacent roofing membrane that is positioned atop the roof surface. The edges may be between 1 and 4 inches wide to enable welding of adjacent roofing membranes.

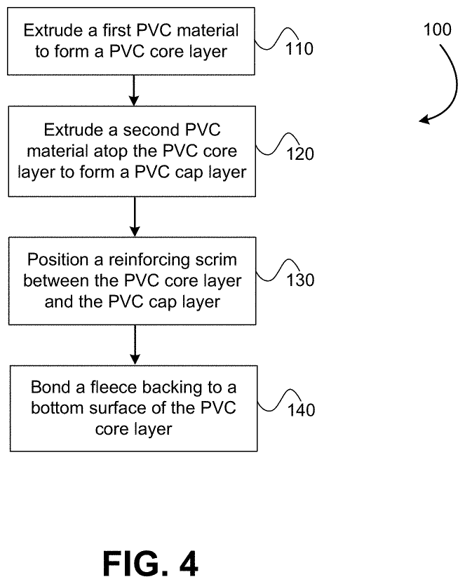

Referring to FIG. 4, illustrated is a method 100 of making or forming a roofing membrane. At block 110, a first polyvinyl chloride (PVC) material is extruded to form a PVC core layer of the roofing membrane. At block 120, a second PVC material is extruded atop the PVC core layer to form a PVC cap layer of the roofing membrane. As described herein, the PVC cap layer may include or consist of a polyvinyl chloride resin having a molecular weight as described herein and a solid polymeric plasticizer having a having a molecular weight as described herein. The PVC cap layer may include between 50 and 80 weight percent of the polyvinyl chloride resin and between 1 and 50 weight percent of the solid polymeric plasticizer. The PVC cap layer more commonly includes between 10 and 35 weight percent of the solid polymeric plasticizer and most commonly between 18 and 25 weight percent of the solid polymeric plasticizer. The PVC cap layer may have any composition described herein. Likewise, the PVC core may have any composition described herein.

At block 130, the method may optionally include positioning a reinforcing scrim between the PVC core layer and the PVC cap layer. In some embodiments, the reinforcing scrim may be positioned on PVC core layer before the second PVC material is extruded atop the PVC core layer. In other embodiments, the reinforcing scrim may be positioned between the PVC core layer and the PVC cap layer and the two layers may be laminated together with the reinforcing scrim positioned there between. At block 140, the method may optionally include bonding or laminating a fleece backing to a bottom surface of the PVC core layer. The steps of blocks 130 and 140 may both be omitted, or only one of the steps may be omitted as desired. Similarly, in some embodiments, both step 130 and step 140 may be performed to manufacture or form a roofing membrane having a desired structure and composition.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the device” includes reference to one or more devices and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

1. A roofing membrane, comprising:
a polyvinyl chloride (PVC) core layer that forms a bottom layer of the roofing membrane; and
a PVC cap layer positioned atop the PVC core layer so that the PVC cap layer forms a top layer of the roofing membrane, the PVVC cap layer comprising:
polyvinyl chloride resin having a molecular weight, as expressed in K-value, of between 54 and 75;
a solid polymeric plasticizer having a having a molecular weight (Mw) of between 200,000 and 500,000;
a liquid plasticizer; and
an acrylic processing aid.

2. The roofing membrane of claim 1, wherein the PVC cap layer comprises between 50 and 80 weight percent of the polyvinyl chloride resin, between 1 and 50 weight percent of the solid polymeric plasticizer, between 10 and 40 weight percent of the liquid plasticizer, and between 0.5 and 5 weight percent of the acrylic processing aid.

3. The roofing membrane of claim 2, wherein the solid polymeric plasticizer comprises ethylene butyl acrylate carbon monoxide copolymers.

4. The roofing membrane of claim 2, wherein the liquid plasticizer comprises a linear phthalate, a branched phthalate, a trimellitate, or any combination thereof.

5. The roofing membrane of claim 2, wherein the acrylic processing aid comprises a fusion aid, a lubricating processing aid, a high molecular weight lubricant, or a combination thereof.

6. The roofing membrane of claim 2, wherein the roofing membrane further comprises a fiber scrim positioned between the PVC core layer and the PVC cap layer.

7. The roofing membrane of claim 6, wherein the fiber scrim consists of polyester or polyethylene terephthalate fibers.

8. The roofing membrane of claim 2, wherein the roofing membrane further comprises a fleece backing applied to a bottom surface of the PVC core layer.

9. The roofing membrane of claim 8, wherein the fleece backing comprises polyester or polyethylene terephthalate.

10. A roofing membrane, comprising:
a polyvinyl chloride (PVC) core layer; and
a PVC cap layer positioned atop the PVC core layer, the PVC cap layer comprising:
polyvinyl chloride resin having a molecular weight, as expressed in K-value, of between 54 and 75; and
a solid polymeric plasticizer having a molecular weight (Mw) of between 200,000 and 500,000.

11. The membrane of claim 10, wherein the PVC cap layer further comprises a liquid plasticizer.

12. The membrane of claim 10, wherein the PVC cap layer further comprises an acrylic processing aid.

13. The membrane of claim 10, wherein the roofing membrane further comprises a reinforcing scrim disposed between the PVC core layer and the PVC cap layer.

14. The membrane of claim 10, wherein the roofing membrane further comprises a fleece backing applied to a bottom surface of the PVC core layer.

15. The membrane of claim 10, wherein the PVC cap layer comprises between 50 and 80 weight percent of the polyvinyl chloride resin and between 18 and 25 weight percent of the solid polymeric plasticizer.

16. The membrane of claim 10, wherein the solid polymeric plasticizer comprises ethylene butyl acrylate carbon monoxide copolymers.

17. A method of making a roofing membrane, the method comprising:
extruding a first polyvinyl chloride (PVC) material to form a PVC core layer of the roofing membrane; and
extruding a second PVC material atop the PVC core layer to form a PVC cap layer of the roofing membrane;
wherein the PVC cap layer comprises:
polyvinyl chloride resin having a molecular weight, as expressed in K-value, of between 54 and 75; and
a solid polymeric plasticizer having a having a molecular weight (Mw) of between 200,000 and 500,000.

18. The method of claim 17, further comprising positioning a reinforcing scrim between the PVC core layer and the PVC cap layer.

19. The method of claim 17, further comprising bonding a fleece backing to a bottom surface of the PVC core layer.

20. The method of claim 17, wherein the PVC cap layer comprises between 50 and 80 weight percent of the polyvinyl chloride resin and between 18 and 25 weight percent of the solid polymeric plasticizer.
